(19) United States
(12) Patent Application Publication
(10) Pub. No.: US 2021/0232308 A1
(43) Pub. Date: Jul. 29, 2021

(54) SYSTEMS, DEVICES, AND METHODS FOR PROVIDING LOCALIZED HAPTIC EFFECTS

(71) Applicant: Immersion Corporation, San Francisco, CA (US)

(72) Inventors: Juan Manuel CRUZ HERNANDEZ, Montreal (CA); Jamal SABOUNE, Montreal (CA); Peyman KARIMI ESKANDARY, Montreal (CA); Vahid KHOSHKAVA, Montreal (CA); Majid SHEIKHOLESLAMI, Burlington (CA); Lionel BRAVARD, Montreal (CA); Simon FOREST, Montreal (CA)

(21) Appl. No.: 17/159,711

(22) Filed: Jan. 27, 2021

Related U.S. Application Data
(60) Provisional application No. 62/966,995, filed on Jan. 28, 2020.

(51) Int. Cl. G06F 3/0488; G06F 3/01

(52) U.S. Cl. CPC G06F 3/04886; G06F 3/016

(57) ABSTRACT

Systems, methods, and devices include at least one actuator positioned within proximity of a user interface (UI) region of an interactive surface. The UI region outputs information to a user and receives input from the user. The at least one actuator provides a haptic effect to the user when interacting with the UI region. The system also includes at least one isolation element positioned adjacent to the at least one actuator. The at least one isolation element suppresses transmission of the haptic effect to an additional UI region of the interactive surface.

### CROSS-REFERENCE TO RELATED APPLICATION

This application claims the benefit of prior U.S. Application Ser. No. 62/966,995, filed Jan. 28, 2020, which is hereby incorporated by reference in its entirety for all purposes.

### FIELD

Embodiments hereof relate to structures, systems and methods for delivering haptic effects to an interactive surface.

### BACKGROUND

Electronic device manufacturers strive to produce a rich interface for users. Many devices use visual and auditory cues to provide feedback to a user. In some interface devices, a kinesthetic effect (such as active and resistive force feedback) and/or a tactile effect (such as vibration, texture, and heat) are also provided to the user. Kinesthetic effects and tactile effects may more generally be referred to as “haptic feedback” or “haptic effects”. Haptic feedback can provide cues that enhance and simplify the user interface. For example, vibrotactile haptic effects may be useful in providing cues to users of electronic devices to alert the user to specific events or provide realistic feedback to create greater sensory immersion within an actual, simulated or virtual environment. Such systems may have applications in user interfaces, gaming, automotive, consumer electronics and other user interfaces in actual, simulated or virtual environments.

Haptic effects generated by haptic-enabled electronic devices or surfaces may not be suitable for all applications. For example, some electronic devices or haptically-enabled surfaces may be not be able to provide localized haptic effects. As such, there is a need for systems and devices that deliver localized haptic effects to haptically-enabled surfaces and the users interacting with the haptically-enabled surfaces.

### BRIEF SUMMARY

In one aspect, the present disclosure provides a system for delivering localized haptics. The system includes at least one actuator positioned within proximity of a user interface (UI) region of an interactive surface. The UI region outputs information to a user and receives input from the user. The at least one actuator provides a haptic effect to the user when interacting with the UI region. The system also includes at least one isolation element positioned adjacent to the at least one actuator. The at least one isolation element suppresses transmission of the haptic effect to an additional UI region of the interactive surface.

In another aspect, the present disclosure provides an interactive device. The device includes an interactive surface comprising a user interface (UI) region. The device also comprises at least one actuator positioned within proximity of the UI region. The UI region outputs information to a user and receives input from the user. The at least one actuator provides a haptic effect to the user when interacting with the UI region. The device also includes at least one isolation element positioned adjacent to the at least one actuator. The at least one isolation element suppresses transmission of the haptic effect to an additional UI region of the interactive surface.

In another aspect, the present disclosure provides a method of providing localized haptics. The method includes determining that user interaction has been initiated at a user interface (UI) region of a touch surface. The method also includes generating a least one haptic effect in proximity to the UI region. Transmission of the haptic effect to an additional UI region of the interactive surface is suppressed.

Numerous other aspects are provided.

### BRIEF DESCRIPTION OF DRAWINGS

The foregoing and other features and advantages of the present invention will be apparent from the following description of embodiments hereof as illustrated in the accompanying drawings. The accompanying drawings, which are incorporated herein and form a part of the specification, further serve to explain the principles of various embodiments described herein and to enable a person skilled in the pertinent art to make and use various embodiments described herein. The drawings are not to scale.

FIGS. 1A-1C illustrate examples of interactive devices according to an embodiment herewith.

FIGS. 2A-2E illustrate various examples of interactive surfaces that provide localized haptic effects according to an embodiment herewith.

FIG. 3 illustrates one example of the placement and number of UI regions according to an embodiment herewith.

FIGS. 4A-4D illustrates a side views and bottom views of an interactive layer that includes examples of isolation elements for providing localized haptic effects according to an embodiment herewith.

FIG. 5 illustrates a side view of an interactive layer that includes pin actuators according to an embodiment herewith.

FIG. 6 illustrates a side view of an interactive layer that includes magnetic actuators according to an embodiment herewith.

FIG. 7 illustrates a side view of an interactive layer that includes piezoelectric actuators according to an embodiment herewith.

FIG. 8 illustrates a side view of an interactive layer that includes electrode patch actuators according to an embodiment herewith.

FIG. 9 illustrates a side view of an interactive layer that includes electrostatic plate actuators according to an embodiment herewith.

FIG. 10 illustrates a side view of an interactive surface that includes a series of actuators according to an embodiment herewith.

FIG. 11A illustrates examples of standing wave interference patterns that can be generated in the interactive surface according to an embodiment herewith.

FIG. 11B illustrates synthesizing and approximating velocity field in order to realize a specific velocity field at the given time according to an embodiment herewith.

FIGS. 12A and 12B illustrate an example of striking an interactive surface and measuring the resulting waves according to an embodiment herewith.

FIG. 13 illustrates one example of an algorithm for using time reversal techniques according to an embodiment herewith.

FIGS. 14A and 14B illustrate an example of an interactive surface that includes an array of individual cells according to an embodiment herewith.

### DETAILED DESCRIPTION

Specific embodiments of the present invention are now described with reference to the figures. The following detailed description is merely exemplary in nature and is not intended to limit the present invention or the application and uses thereof. Furthermore, there is no intention to be bound by any expressed or implied theory presented in the preceding technical field, background, brief summary or the following detailed description.

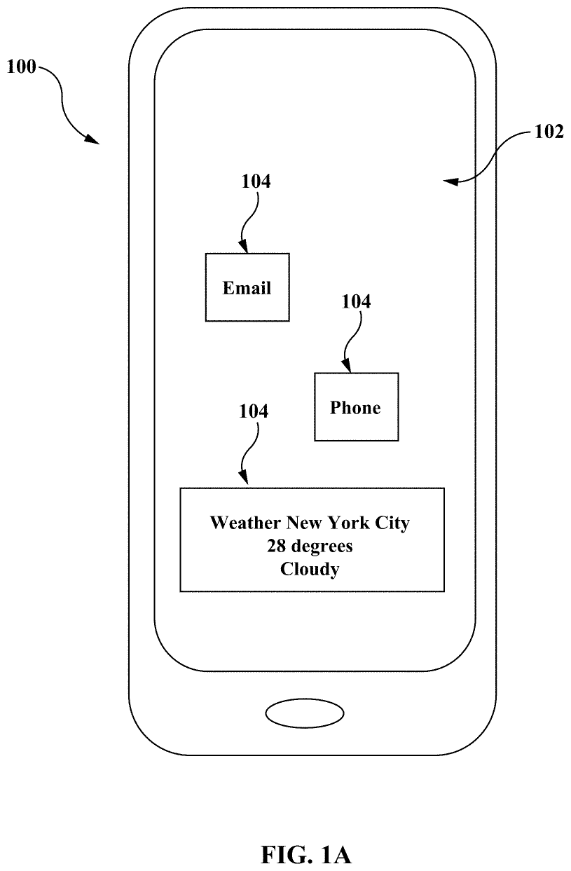

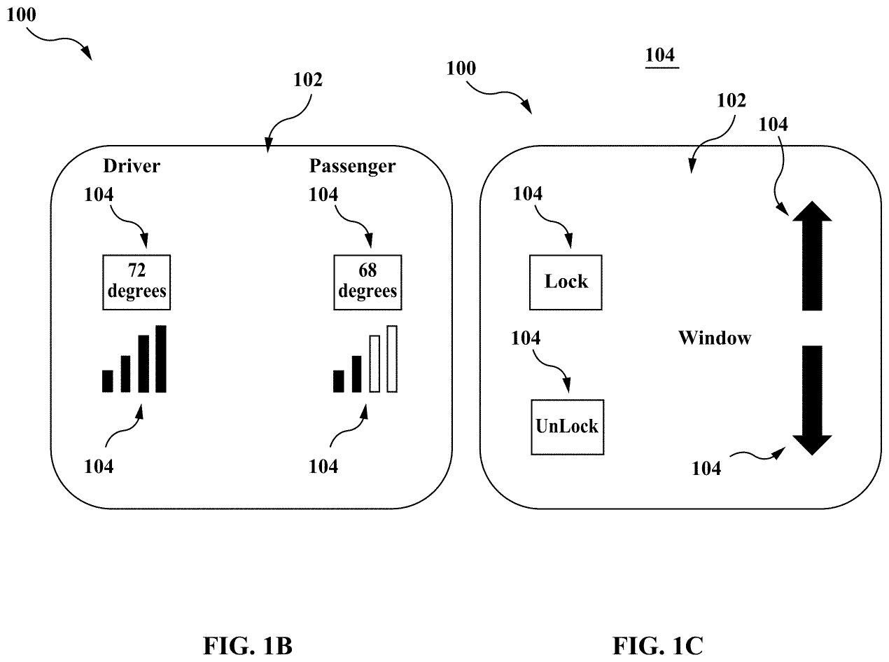

FIGS. 1A-1C illustrate examples of interactive devices 100 in accordance with an embodiment hereof. One skilled in the art will realize that FIGS. 1A-1C illustrate several examples of interactive devices and that existing components illustrated in FIGS. 1A-1C may be removed and/or additional components may be added to the support structure without departing from the scope of embodiments described herein.

As illustrated in FIG. 1A, an interactive device 100 includes an interactive surface 102. The interactive surface 102 can be configured to display one or more User Interface (“UI”) regions 104. The interactive surface 102 may be a display screen or any type of haptically-enabled touch surface. The interactive device 100 may comprise any type of electronic device suitable for providing an interactive surface 102 capable of displaying the UI regions 104 to a user and receiving input from the user via the UI regions 104. For example, the interactive device 100 can include a tablet, display screen, laptop, smart phone, mobile phone, control panel, a dashboard, a control console, etc. Likewise, for example, in a vehicle control panel, the interactive surface 102 may be a car dashboard, a car door, an arm rest, a control console, or any other surface capable of displaying one or more UI regions 104.

As described herein, each of the UI regions 104 can define a portion of the interactive surface 102 that is associated with a functionality, an operation, an application, a control, etc. provided by the interactive device 100. In embodiments, the UI regions 104 can be configured to display information to a user that conveys an operation and function, which is activated or controlled when a user interacts with the UI regions 104. In embodiments, the UI regions 104 can be configured to detect and sense user interaction with the UI regions 104. For example, the UI regions 104 can be configured to detect and sense a user input element (e.g., finger, hand, stylus, etc.) interacting with the UI regions 104 (e.g., proximity position, a touch, a tap, a swipe, etc.) When the interaction is detected and sensed at the UI region 104, the interactive device 100 performs an action associated with the UI regions 104 interacted with by the user, e.g., performs the functionality, executes an operation, launches an application, controls aspects of the interactive device 100 according to the user's input, etc. As such, the portion of the interactive surface 102 defined by the UI regions 104 can include the necessary components to display information to a user and detect and sense the user interaction.

In embodiments, the interactive device 100 can also be configured to output haptic effects to a user interacting with the interactive surface 102. As described herein, a haptic effect includes a physical effect and/or sensation that is produced by the interactive surface 102, or a portion of the interactive surface 102. In embodiments, a haptic effect can include a kinesthetic effect (such as active and resistive force feedback) and/or a tactile effect (such as vibration, texture, and heat). For example, the haptic effect can include a sensation that is perceivable by a user's body part touching or interacting with the interactive surface 102, e.g., a sensation in the form of a vibration, texture, displacement, force, etc. In embodiments, the interactive surface 102 can be configured to provide localized haptic effects as described below in further detail.

In embodiments, the interactive device 100, including the interactive surface 102 and UI elements 104, can be utilized in any application that requires output of information to a user and input of information from the user. For example, as illustrated in FIG. 1B and 1C, the interactive device 100 can be in the form of control consoles, dashboards or panels for a vehicle. In this example, the interactive surface 102 can display UI regions 104 that allow a user 106 to select and control various features and/or functions of the vehicle using a user input element 108 (e.g., finger.) For example, as illustrated in FIG. 1B, the interactive surface 102 can display UI regions 104 that allow the user 106 to control the environmental settings of the vehicle, such as driver side temperature and the passenger side temperature. The user 106 can change the driver side temperature and/or the passenger side temperature by interacting (e.g., tapping the UI region 104, sliding the user input element, etc.) with the associated UI regions 104. Likewise, for example, as illustrated in FIG. 1C, the interactive surface 102 can display UI regions 104 that allow the user 106 to control functionality associated with a door (e.g., locking the door, opening a window, etc.) The user 106 can control the functionality associated with the door by interacting (e.g., tapping the UI region 104, sliding the user input element 108, etc.) with the associated UI regions 104. For instance, the user 106 can open the window by sliding the user input element 108 (e.g., finger) in the y-direction (e.g., upward or downward) the UI region 104 associated with window control, as illustrated in FIG. 1C.

In embodiments, it is desirable to provide haptic effects to the interactive surface 102, or a portion of the interactive surface 102, that is associated with an activated UI region 104. For example, the haptic effects can provide confirmation and feedback that the user is interacting with a particular UI region 104. In embodiments, because the interactive surface 102 can be relatively large (e.g., car door, dashboard, etc.), it is desirable to provide haptic effects that are localized at each UI region 104. Moreover, because each UI region 104 may have a distinct function, it may be desirable to isolate each individual UI regions 104 so that an associated haptic effect is only felt at that UI region 104. For example, as illustrated in FIG. 1B, the UI regions 104 controlling the temperature of the passenger side and driver side of the vehicle may be located relatively close on the interactive surface 102. If one user is interacting with the UI region 104 associated with the driver side temperature, the haptic effects output to the UI region 104 associated with the driver side temperature may be localized so that they do not propagate to other UI regions 104. For instance, if a second user is interacting with the UI region 104 associated with the passenger side temperature, the haptic effects for the UI region 104 associated with the driver side temperature are localized and do not propagate into the UI region 104 associated with the passenger side. This prevents the second user perceiving the haptic effects associated with the driver side temperature interactions.

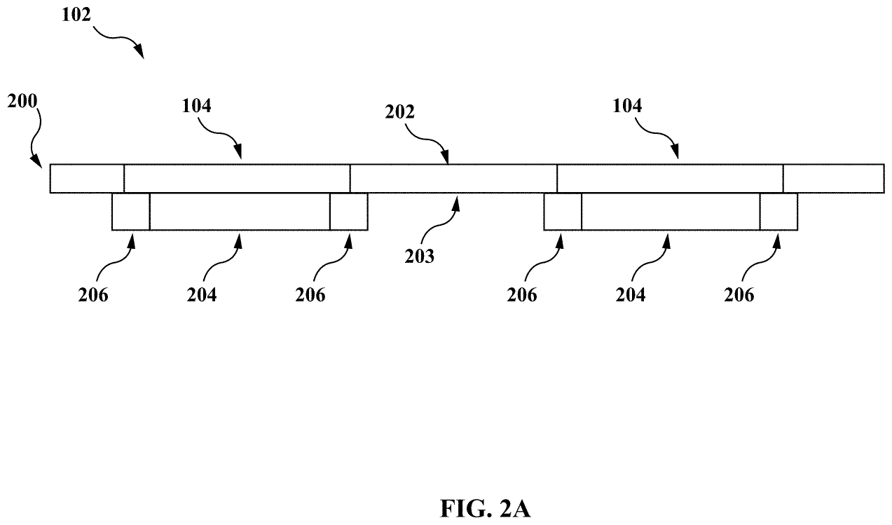

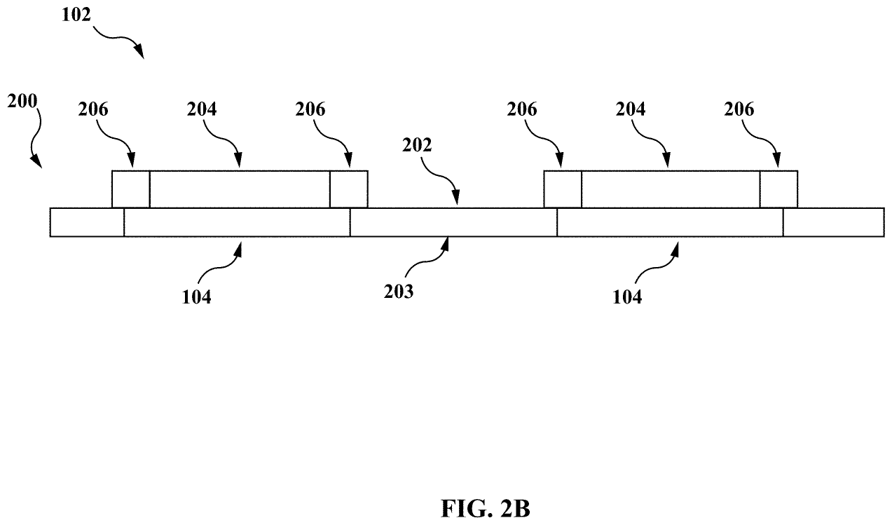

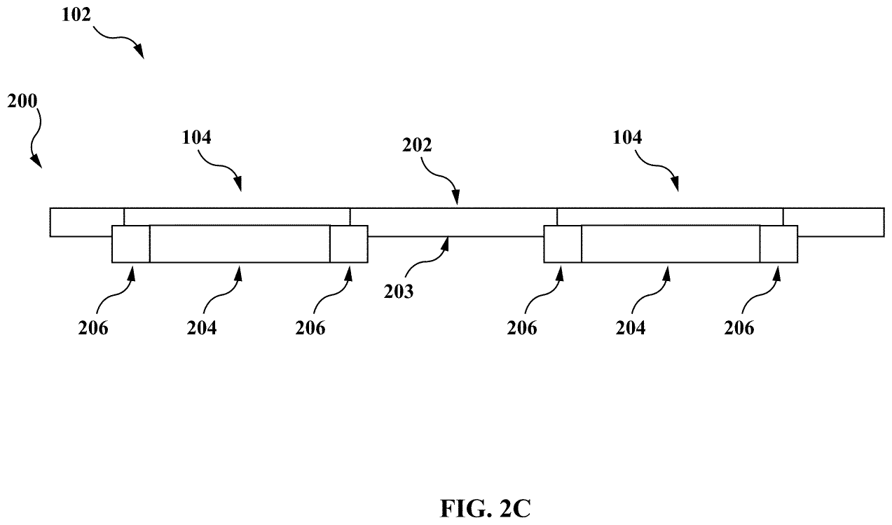

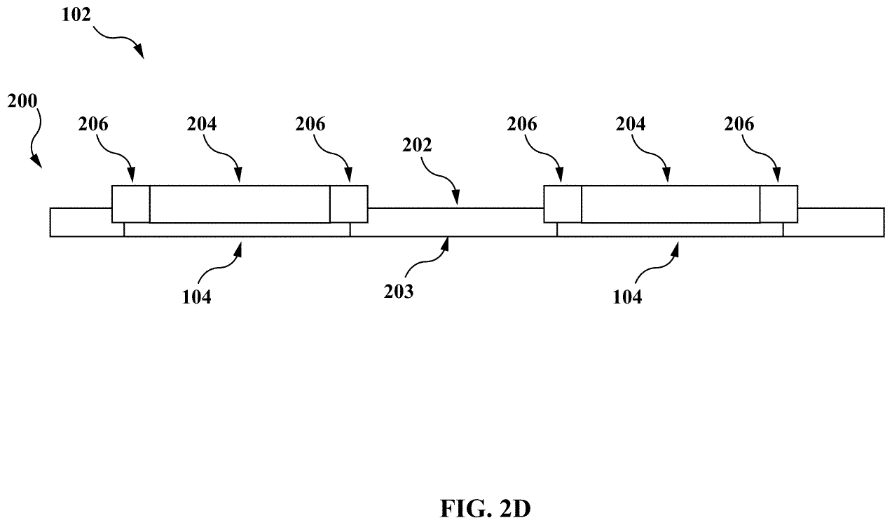

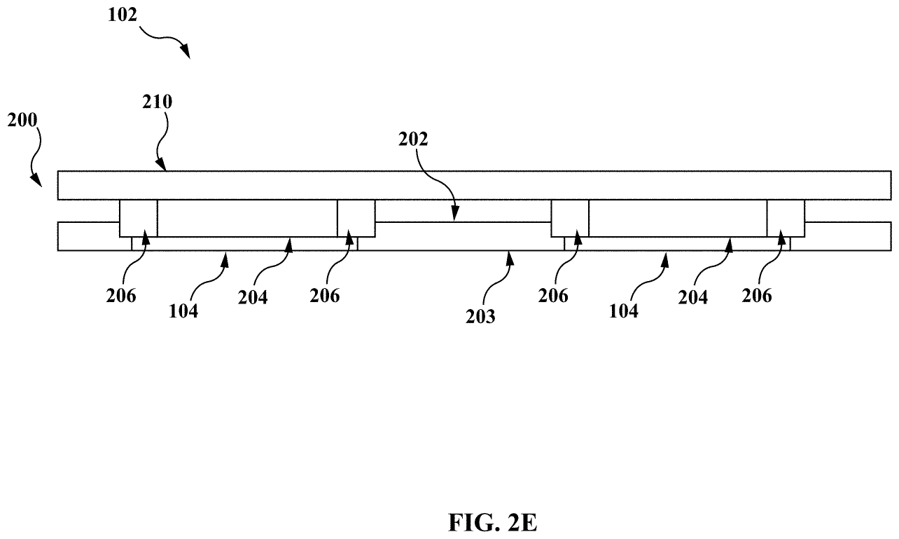

FIGS. 2A-2E illustrate various examples of interactive surfaces 102 that provide localized haptic effects in accordance with an embodiment hereof. One skilled in the art will realize that FIGS. 2A-2E illustrate one example of interactive surfaces and that existing components illustrated in FIGS. 2A-2E may be removed and/or additional components may be added to the support structure without departing from the scope of embodiments described herein.

As illustrated in FIG. 2A, in some embodiments, the interactive surface 102 can include an interactive layer 200 that provides a touch surface 202. One or more UI regions 104 can be defined in the interactive layer 200. The interactive layer 200 can include the necessary components to display user interface elements in the UI regions 104. For example, the interactive layer 200 can include light emitting diodes, liquid crystal display elements, etc. that output information that is perceivable to a user. The interactive layer 200 can also include sensing elements that are configured to detect and sense user interaction. For example, the interactive layer 200 can include pressure sensors, proximity sensors, capacitive sensors, etc. In embodiments, the touch surface 202 can be formed of a material that allow light to pass from the UI regions 104 to be viewable by a user. For example, the touch surface 202 can be formed of any material that provides the functionality of the interactive surface, as described below in further detail.

In some embodiments, to generate haptic effects, one or more actuators 204 can be positioned on a surface 203, opposite the touch surface 202. The actuators 204 can be positioned to correspond to the UI regions 104 to deliver the haptic effects to corresponding UI regions 104. In any of the embodiments described herein, the actuators 204 can be or include any suitable output device known in the art. For example, the actuators 204 can include thin film actuators, such as macro-fiber composite (MFC) actuators, piezoelectric material actuators, smart material actuators, electro-polymer actuators, and others. The actuators 204 can further include inertial or kinesthetic actuators, eccentric rotating mass (“ERM”) actuators in which an eccentric mass is moved by a motor, linear resonant actuators (“LRAs”), vibrotactile actuators, shape memory alloys, and/or any combination of actuators. Examples of actuators are described below in further detail.

In embodiments, to isolate the haptic effects to a UI region 104, one or more isolation elements 206 can be formed on the surface 203. The isolation elements 206 can operate to suppress transmission of haptic effects from one UI regions 104 to other UI regions 104. In some embodiments, the isolation elements 206 can be formed of materials that dampen or suppress haptic effects (e.g., motion, vibration, etc.) In some embodiments, the isolation elements 206 can be formed of materials that have a stiffness that is lower than a stiffness of other components of the interactive layer 200. In some embodiments, the isolation elements 206 can include spring-damping components that dampen or suppress haptic effects (e.g., motion, vibration, etc.) In some embodiments, the isolation elements 206 can include materials and/or components that dynamically change properties (e.g., dynamically change stiffness, dynamically change mass, etc.) to dampen or suppress haptic effects (e.g., motion, vibration, etc.)

While described above as being positioned on the surface 203, one skilled in the art will realize that the actuators 204 and the isolation elements 206 can be positioned at different location of the interactive surface 102. In some embodiments, as illustrated in FIG. 2B, the actuators 204 and the isolation elements 206 can be positioned on the touch surface 202. In some embodiments, as illustrated in FIG. 2C and FIG. 2D, the actuators 204 and the isolation elements 206 can be positioned to be partially (or completely) contained within the interactive layer 200. For example, as illustrated in FIG. 2C, the actuators 204 and the isolation elements 206 can be positioned partially within the surface 203. Likewise, for example, as illustrated in FIG. 2D, the actuators 204 and the isolation elements 206 can be positioned partially within the touch surface 202.

In any of the embodiments described herein, it may be desirable for the touch surface 202 to be continuous (e.g., planar without bumps, ridges, indentions, etc.) To provide a continuous surface for the touch surface 202, as illustrated in FIG. 2E, a cosmetic layer 210 can be positioned adjacent to the touch surface 202. The cosmetic layer 210 can mask discontinuities caused by the different components of the interactive surface 102. For example, as illustrated in FIG. 2E, the cosmetic layer 210 can be positioned over the touch surface 202, the actuators 204, and the isolation elements 206 to provide a continuous surface.

In some embodiment, the cosmetic layer 210 can operate as the touch surface 202, for example, by including one or more touch sensor (e.g., capacitive). In some embodiments, the cosmetic layer 210 can operate as a passive layer that provides the touch surface 202 with a desired texture and look. The cosmetic layer 210 can have certain physical and mechanical properties to meet required expectations for localized haptic effects. The cosmetic layer 210 can be translucent so as to allow light from the UI regions 104 to show through, but avoid exposing underlying mechanics. The cosmetic layer 210 can be thick enough to mask any underneath spacing/clearance from the actuators 204 and the isolation elements 206 (e.g., moving parts, base, etc.) such that the user does not feel any discontinuity on the interactive surface 102.

In embodiments, the cosmetic layer 210 can have a thickness that does not interfere with the haptic effects. For example, the thickness can be constrained to certain values in order to not increase stiffness to the actuators 204 thereby lowering performance of the haptic effects. Depending on the actuators 204 (or the extent of the deformation caused by the actuators 204), the cosmetic layer 210 can be flexible enough with minimum hysteresis to create a consistent haptic effect. Otherwise, after a long life cycle, the cosmetic layer 210 may undergo creep and a change of the property and adding complexity to the haptic design and user experience. Additionally, cosmetic layer 210 can have a low damping factor in order to not weaken the strength of the perceived haptic effects.

In embodiments, the cosmetic layer 210 can be formed of material such as neoprene rubber (the degree of curing being parameter to control the property of all the rubbers), natural rubber, urethane based rubber, ethylene propylene diene monomer (EPDM) rubber, silicon rubber, composite layer (e.g., blending different materials to achieve the required properties, reinforcing a soft material with rigid additives, etc.) and the like. In embodiments, the cosmetic layer 210 can be fabricated using any type of process. In some embodiments, the cosmetic layer 210 can be fabricated, in situ. For example, the cosmetic layer 210 can be fabricated using printing techniques and/or using spray or paint (e.g., Paint Defender Spray Film from 3M) that can be directly sprayed on a surface of the interactive surface 102. In some embodiments, the cosmetic layer 210 can be fabricated separately and mounted on the interactive surface 102 using techniques such as manual installation, thermo-forming, vacuum bagging technique, etc.

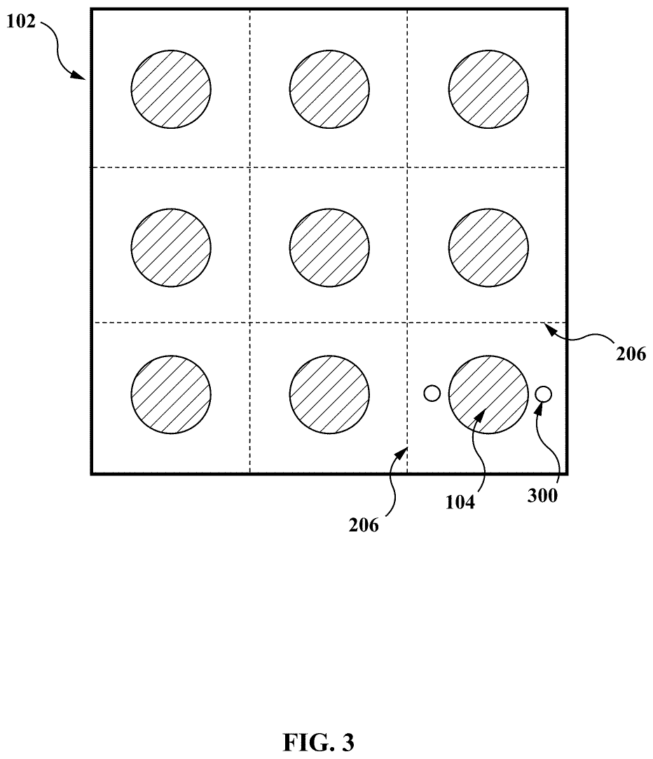

In embodiments, the number and placement of the UI regions 104 can be determined by the particular application and function of the interactive device 100. FIG. 3 illustrates a top view of an example of placement and number of UI regions 104. One skilled in the art will note that FIG. 3 illustrates one example of the placement and number of UI regions 104 and that an interactive device 100 can include any number of UI regions 104 which are positioned at any location on the interactive surface 102.

As illustrated in FIG. 3, the interactive surface 102 can include 9 UI regions 104 formed in a matrix or grid pattern. While FIG. 3 illustrates 9 UI regions 104, one skilled in the art will realize that the interactive surface 102 can include any number of UI regions 104. Likewise, while FIG. 3 illustrates the UI regions 104 are formed in a grid or matrix pattern, one skilled in the art will realize that the UI regions 104 can be formed in an arrangement, whether regular or irregular, depending on the functionality of the interactive device 100.

In embodiments, the actuators 204 can be configured to deliver the haptic effects at the UI regions 104. For example, the actuators 204 can be positioned directly under and/or over the UI regions 104. In some embodiments, the actuators 204 can be positioned to deliver the haptic effects near the UI regions 104. For example, the actuators 204 can be positioned at a location adjacent to the UI regions 104 to delivery haptic effects at a location 300.

In the example, as illustrated in FIG. 3, the isolation elements 206 can be formed between each of the UI regions 104, thereby isolating each UI regions 104. In other embodiments, only certain ones of the UI regions 104 are isolated using the isolation elements 206. For example, if the UI regions are spaced at a large enough distance, the isolation elements 206 may not be required, and the structure of the interactive surface 102 may be sufficient to provide damping between UI regions.

In embodiments, the UI regions 104 can be formed to any size and any shape (e.g., circular, square, irregular, etc.) as required by the operation and functionality of the interactive device 100. In some embodiments, the UI regions 104 can be formed having a same or approximately same size. In some embodiments, one or more of the UI regions 104 can be formed having different sizes. In some embodiments, the UI regions 104 can be formed having square or rectangular shape with dimensions ranging from approximately 10 mm×10 mm to approximately 100 mm×100 mm.

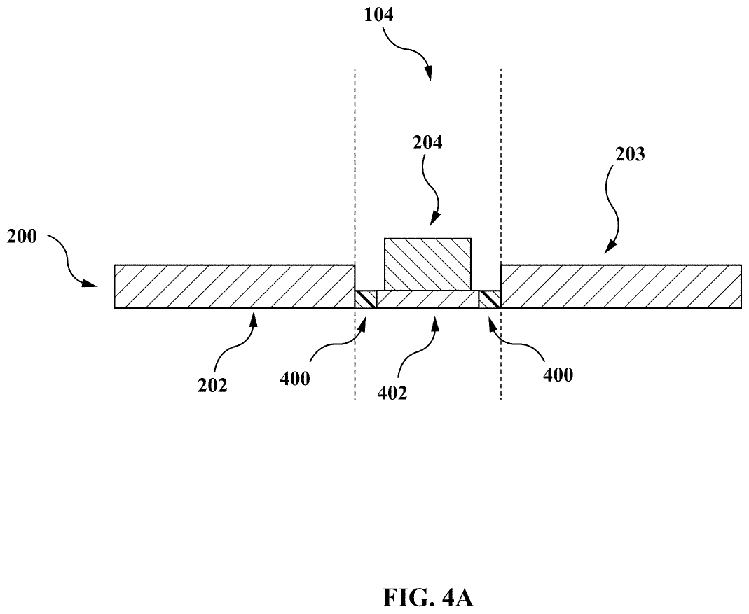

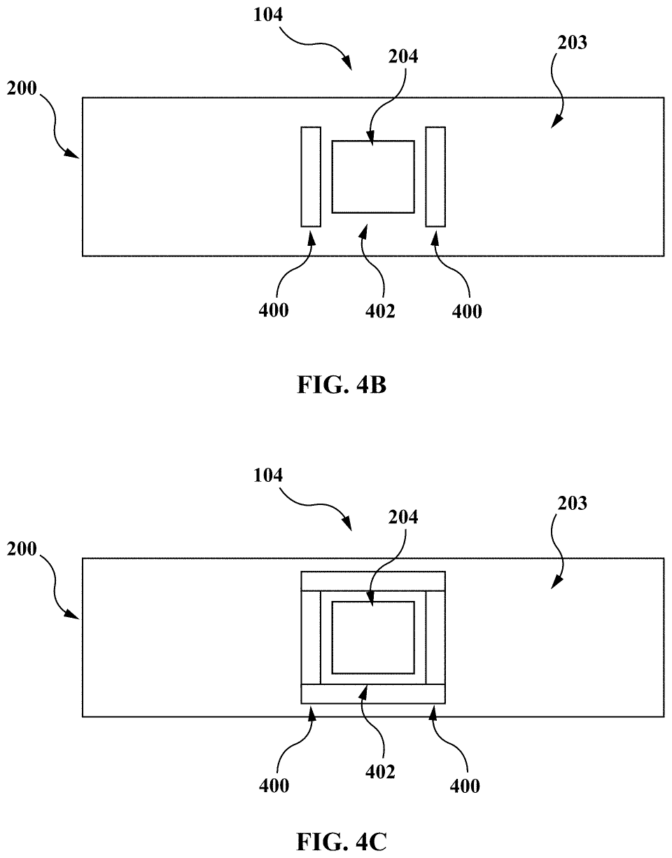

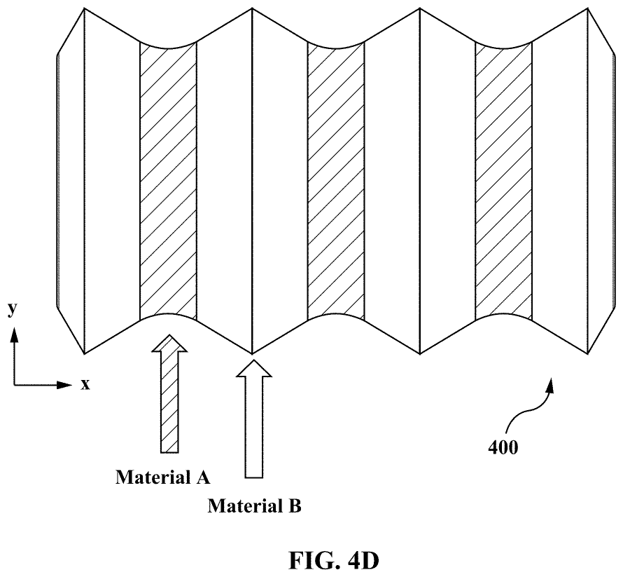

As discussed above, the interactive surface 102 can include the actuators 204 and the isolation elements 206 to provide localized haptic effects. FIGS. 4A-4C illustrate several examples of isolation elements that can be used in the interactive surface 102. One skilled in the art will realize that any of the examples of isolation elements can be utilized with any type of actuator disclosed herein.

FIGS. 4A-4D illustrates a side views and bottom views of the interactive layer 200 that includes examples of isolation elements 400 for providing localized haptic effects. As illustrated in FIG. 4A, the interactive layer 200 includes a UI region 104. To deliver haptic effects to the UI region 104, an actuator 204 can be positioned within the UI region 104. A thickness of the interactive layer 200 in the UI region 104 can be less than the thickness of the surrounding portions of the interactive layer 200. The actuator 204 is positioned within the region of reduced thickness to deliver haptic effects to the touch surface 202 in the UI region 104. To prevent transmission of the haptic effect to other regions of the interactive surface 200, e.g., other UI regions 104 (not shown), the interactive surface can include the isolation elements 400. The isolation elements 400 can be formed of a material that has a stiffness that is less than the surrounding portions of the interactive layer 200. As such, a portion 402 of the interactive layer 200 can move more freely relative to other portions of the interactive layer 200. Additionally, the isolation elements 400 can operate to dampen the haptic effects that are transmitted to other portions of the interactive layer 200.

In some embodiments, the isolation elements 400 may permit motion in the x-direction or z-direction (e.g., side-to-side motion) of portion 402 in a plane parallel to the touch surface 202 while preventing y-direction motion (e.g., up-and-down motion) of portion 402 into and out of the touch surface 202. This motion will prevent deformation of the cosmetic layer 210 (not shown) normal to the touch surface 202. In this manner, the cosmetic layer 210 does not need to be compliant with y-direction of motion (e.g., up-and-down motion) normal to the touch surface 202 which could cause fatigue and wrinkling of the cosmetic layer.

In some embodiments, the isolation elements 400 can be formed of a same or similar material as the interactive layer 200 that has been weakened to reduce the stiffness of the isolation elements 400. In some embodiments, the isolation elements 400 can be formed of different materials than the interactive layer 200. In some embodiments, the isolation elements 400 can be formed as a suspension that supports portion 402 of the interactive layer 200. In this embodiment, the isolation element 400 can be formed as a separate structure including materials that dampen the haptic effects generated by the actuator 204. For example, the isolation elements 400 can be formed of materials containing silicon. In any of the embodiments, the isolation elements 400 can include additional components to assist in the localization of the haptic effects. For example, the isolation elements 400 can include spring-damper modules constructed of materials that absorb the haptic effects (e.g., foam, elastomer, etc.).

In embodiments, the isolation elements 400 can be positioned at one or more locations surrounding the actuator 204. In some embodiments, as illustrated in FIG. 4B (bottom view of the interactive layer 200), the isolation elements 400 can be positioned on opposing sides of the actuator 204. In some embodiments, as illustrated in FIG. 4C (another bottom view of the interactive layer 200), the isolation elements 400 can be positioned on all sides of the actuator 204 to form a “moat” around the actuator 204.

In embodiment, the isolation elements 400 can be formed in a design and materials that allow motion in one direction but limits motion in a section direction. As illustrated in FIG. 4D, an isolation element 400 can be formed in an “accordion” design including alternating different materials, e.g., material A and material B. As shown, the proposed design has two parts (red and greyish). The grey part might be made of soft material (elastomer or flexible material with desired stiffness for the resonant frequency) compared to the red one enabling the structure to move easily in the x-direction. The role of the reddish material is to make sure that the structure does not move in the y-direction by selecting this material out of rigid substrate (carbon fiber, reinforced composite and etc.). This “accordion” structure is one example, but other concepts and designs can be utilized such as such as origami structures.

In alternative embodiments, instead of providing isolation elements 206, 400 in the form of materials that dampen or suppress haptic effects, isolation between UI regions can be provided by dynamically creating regions of increased mass or stiffness adjacent to or surrounding localized UI region 104. Examples of ways in which regions of increased mass or stiffness can be dynamically created will be provided below.

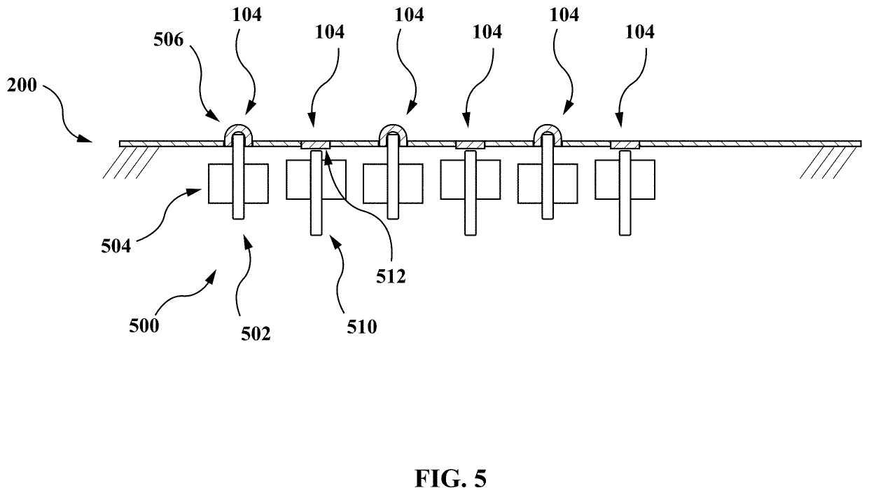

As discussed above, the interactive surface 102 can include the actuators 204 and the isolation elements 206 to provide localized haptic effects. FIGS. 5-9 illustrate several examples of actuators that can be used in the interactive surface 102. In some embodiments, the example actuators can be utilized with separate isolation elements 206, discussed below. In some embodiments, the examples of actuators can operate as the actuators 204 as well as providing the functionality of the isolation elements 206.

FIG. 5 illustrates a side view of the interactive layer 102 that includes pin actuators 500. As illustrated in FIG. 5, the pin actuators 500 include a pin 502 and a motivator 504. The motivator 504 can be configured to actuate the pin 502 and force the pin 502 into a portion 506 of the interactive layer that corresponds to a UI region 104. The motivator 504 can be formed of various components to provide a force to the pin 502, for example, a solenoid with coils and magnets, to push and retract the pin 502 smart material actuators (SMA) to push and retract the pin 502, piezoelectric ceramic actuators to vibrate the pin or to push the pin 502 in the y-direction of motion (e.g., up-and-down motion), and the like.

As described herein, SMA can include materials that change properties when electric or magnetic field are applied (e.g., an electroactive polymer (EAP) material). The EAP material can include, e.g., a polymer in the polyvinylidene fluoride (PVDF) family. Such a polymer can be a homopolymer with PVDF as the only repeating unit, a copolymer (e.g., a terpolymer), or any other type of polymer. In a more specific example, the EAP material may be a P(VDF-TrFE-CFE), i.e. a polymer having vinylidene (VDF), fluoridetrifluoroethylene (TrFE), and chlorofluoroethylene (CFE). In an embodiment, the EAP or other SMA can be substantially transparent to visible light (e.g., a transparency level of 85% or more), so as to allow UI regions to be viewed. In an embodiment, the transparency of the EAP or other SMA can be increased by choosing a lower thickness for the actuation layer. An example thickness of the EAP or other SMA can be on the order of microns (e.g., in a range of 5 μm to 30 μm) or millimeters. The amount of deformation of the EAP or other SMA can also be on the order of microns or millimeters, and can be sufficient for tactile perception.

The portion 506 (or the regions surrounding the portion 506) can have a lower stiffness relative to other portions of the interactive layer 200 such that the pin 502 can hit or vibrate the portion 506 to produce the haptic effects. While not illustrated, the UI region 104 can also include the isolation elements 106, for example, isolation elements 400 described above.

In some embodiment, the pin actuators 500 can be used to assist in localizing the haptic effects. For example, one pin actuator 500 delivers haptic effects to a UI region 104. An adjacent pin actuator 500, e.g., pin actuators 510, can be activated to press against an adjacent UI region 104 without deforming a portion 512 associated with the adjacent UI region 104. As such, the pin actuator 510 can stabilize or stiffen the portion 512 which reduces the ability of a haptic effect from pin 502 from propagating to an adjacent UI region 104. This then localizes the haptic effect created by pin 502 to its UI region 104.

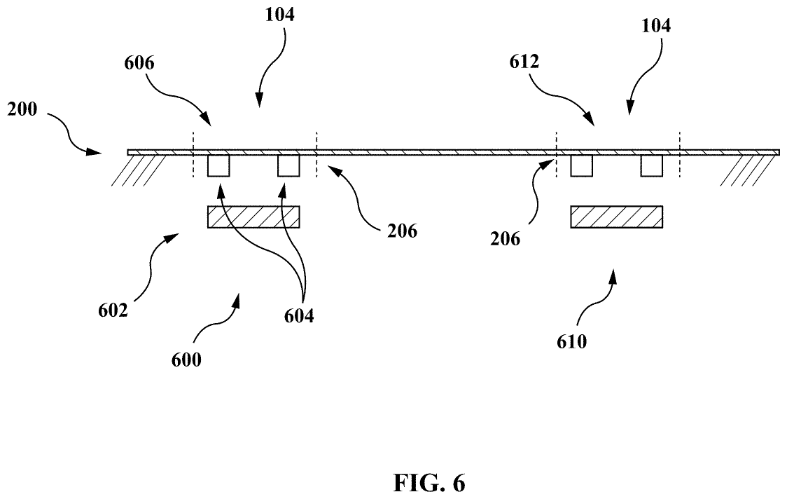

FIG. 6 illustrates a side view of the interactive layer 102 that includes magnetic actuators 600. As illustrated in FIG. 6, the magnetic actuators 600 include a driving magnet (or coil) 602 and a contact magnet (or coil) 604. The driving magnet (or coil) 602 can be configured to actuate the contact magnet (or coil) 604 and force the contact magnet (or coil) 604 into a portion 606 of the interactive layer that corresponds to a UI region 104. For example, currents can be supplied to the driving magnet (or coil) 602 and the contact magnet (or coil) 604 to cause the driving magnet (or coil) 602 and the contact magnet (or coil) 604 to have opposite polarity. As such, the contact magnet (or coil) 604 can be force away from the driving magnet (or coil) 602 thereby deforming the portion 606 of the interactive layer 200. An alternating current can be supplied to the driving magnet (or coil) 602 and the contact magnet (or coil) 604 to produce vibration in the y-direction of motion (e.g., up-and-down motion) of the contact magnet (or coil) 604.

The portion 606 (or the regions surrounding the portion 606) can have a lower stiffness relative to other portions of the interactive layer 200 such that the contact magnet (or coil) 604 can hit or vibrate the portion 606 to produce the haptic effects. Likewise, as illustrated, the UI region 104 can also include the isolation elements 206, for example, isolation elements 400 described above.

In some embodiment, the magnetic actuators 600 can be used to assist in localizing the haptic effects. For example, one magnetic actuator 600 can deliver haptic effects to a UI region 104. An adjacent magnetic actuator 610 can be activated to press against an adjacent UI region 104 without deforming a portion 612 associated with the adjacent UI region 104. As such, the magnetic actuators 610 can stabilize or stiffen the portion 612 and reduce haptic effects from 606 propagating into the potion 612 of the adjacent UI region 104.

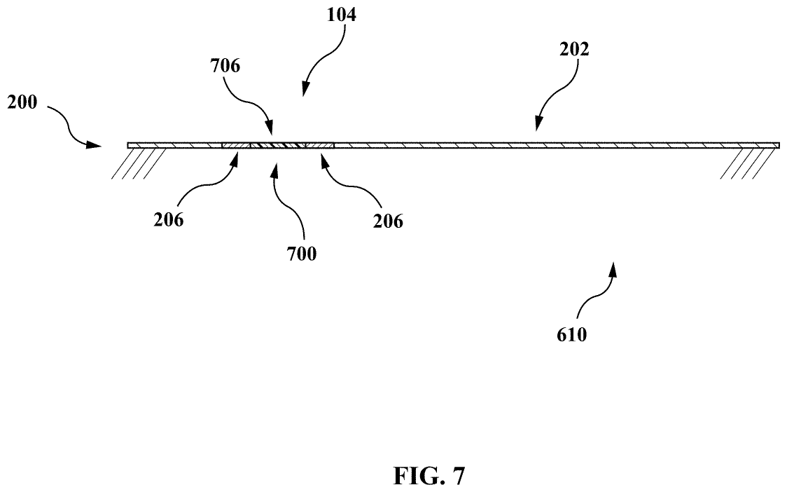

FIG. 7 illustrates a side view of the interactive layer 102 that includes piezoelectric actuators 700. As illustrated in FIG. 7, the piezoelectric actuator 700 can be embedded in the touch surface 202 of the interactive layer 102. The piezoelectric actuator 700 can be form of a material that is transparent or translucent to allow light from the UI region 104 to be visible at the touch surface 202. The material can also be response to an electric filed applied to the piezoelectric actuator 700. For example, when an electric current is applied, the piezoelectric actuator 700 can be configured to deform, thereby producing haptic effect in a portion 706 of the interactive layer 200. An alternating electric field can be supplied to the piezoelectric actuator 700 to produce vibration (e.g., piezoelectric actuator 700). In embodiments, the piezoelectric actuators 700 can include material such as crystalline materials, ceramics (e.g., barium titanate, lead zirconate titanate, etc.).

The portion 706 (or the regions surrounding the portion 706) can have a lower stiffness relative to other portions of the interactive layer 200 such that the piezoelectric actuator 700 can hit or vibrate the portion 706 to produce the haptic effects. Likewise, as illustrated, the UI region 104 can also include the isolation elements 206, for example, isolation elements 400 described above.

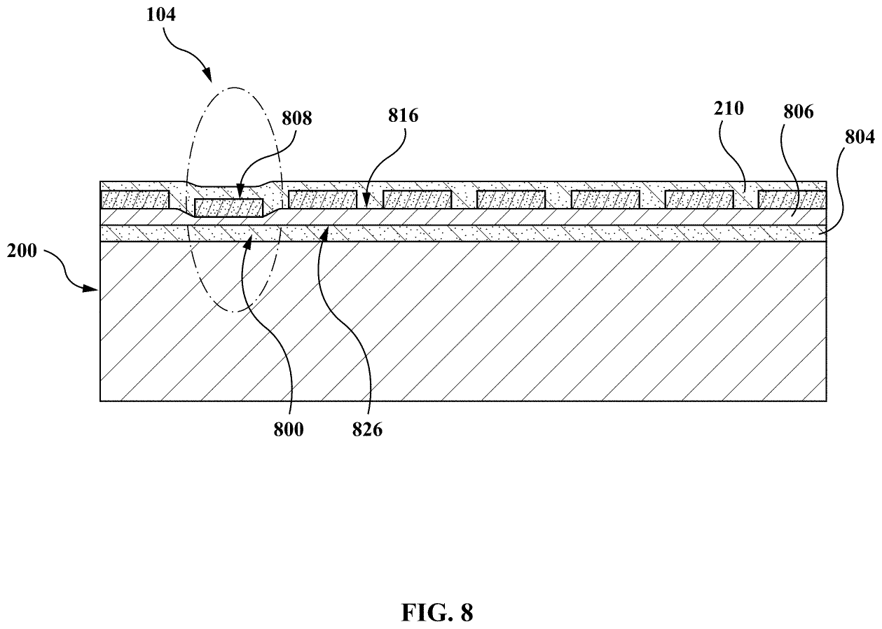

FIG. 8 illustrates a side view of the interactive layer 102 that includes electrode patch actuators 800. As disclosed herein, the electrode patch actuators 800 can be formed of a single piece of EAP material that form an EAP layer can be configured to provide one or more localized haptic effects by having an electrode layer deposited thereon, and having the electrode layer patterned into a plurality of electrode patches disposed at respective regions of the EAP material. Each electrode patch may be used to deform the EAP material at a region of the EAP material at which the electrode patch is disposed. For instance, the surface of the EAP material may be electrode-deposited with a patterned format to provide haptic feedback. Another electrode layer may be disposed on the opposite side of the EAP material to function as an electrical ground electrode. Both electrode layers may also be substantially transparent. In an embodiment, the EAP layer and the two electrode layers may make up a haptic-enabled layer. In an embodiment, the haptic-enabled layer may be an external or outer layer mounted on an exterior (i.e., outer) surface of a display layer of the display device.

For example, as illustrated in FIG. 8, an electrode patch actuator 800 includes the first electrode layer 804, the actuation layer 806, electrode patches 808 of a second electrode layer. The first electrode layer 804, the actuation layer 806, and the second electrode layer are collectively disposed on the touch surface 202 of the interactive layer 102.

In some embodiment, the cosmetic layer 210 can be disposed at least partially over the plurality of electrode patches 808. The cosmetic layer 210 can receive contact from a user's finger or other body part. The cosmetic layer 210 may be sufficiently flexible, such that deformation of a UI region 104 of the actuation layer 806 will also cause deformation of the cosmetic layer 210. In an embodiment, a plurality of internal touch sensors (e.g., capacitive touch sensors) may be embedded in the cosmetic layer 210. In another embodiment, the cosmetic layer 210 may be omitted.

In an embodiment, the first electrode layer 804 can include a substantially transparent conductive material, such as indium tin oxide. In an embodiment, a material may be considered to be substantially transparent if it has a transparency of 50% or higher. In an embodiment, the first electrode layer 804 may have a higher transparency level than 50% (e.g., 80%, 85%, 90%, etc.).

In an embodiment, a first side 816 of the actuation layer 806 (e.g., a rear side) being disposed on and electrically connected to the first electrode layer 804. Thus, the first side 816 of the actuation layer 806 can have the same electrical potential as the conductive material of the first electrode layer 804. In an embodiment, the first electrode layer 804 can be a ground electrode that is electrically connected to a ground potential. In such an embodiment, the entire first side 816 of the actuation layer, or at least a portion of the first side 816 in contact with the first electrode layer 804, may also be at the ground potential.

In embodiments, the electrode patch 808 of the plurality of electrode patches form the second electrode layer, and can be disposed on a second and opposite side 826 of the actuation layer 806. The plurality of electrode patches can be disposed on the single piece of actuatable material that forms the actuation layer 806. Further, the plurality of electrode patches 808 can be electrically connected to a plurality of respective regions of the actuatable material, corresponding to the UI regions 104, and can be electrically isolated from each other by having an insulating material or gap between the electrode patches. The electrical isolation can allow a haptic driving signal to be applied to only a subset of the plurality of electrode patches (e.g., only to electrode 808). The embodiments, the plurality of electrode patches can be formed in an array or other configuration to match the UI regions 104.

In embodiments, the electrode patch 808 can be disposed on a plurality of respective regions of the actuatable material corresponding to the UI region 104. The actuatable material (e.g., EAP) material of the actuation layer 806 can be configured to deform at the UI region 104 upon the haptic driving signal creating a difference in electrical potential between the first side 816 and the second side 826 of the actuation layer 806. As such, haptic effects can be delivered to the UI region 104.

The regions surrounding the electrode patch can have a lower stiffness relative to other portions of the interactive layer cosmetic layer 210. Likewise, the UI region 104 can also include the isolation elements (not shown), for example, isolation elements 400 described above. A complete description of electrode patch actuators can be found, for example, in U.S. Pat. App. Pub. No. 2018/0356889 A1 assigned to IMMERSION CORP., the content of which is incorporated by reference herein.

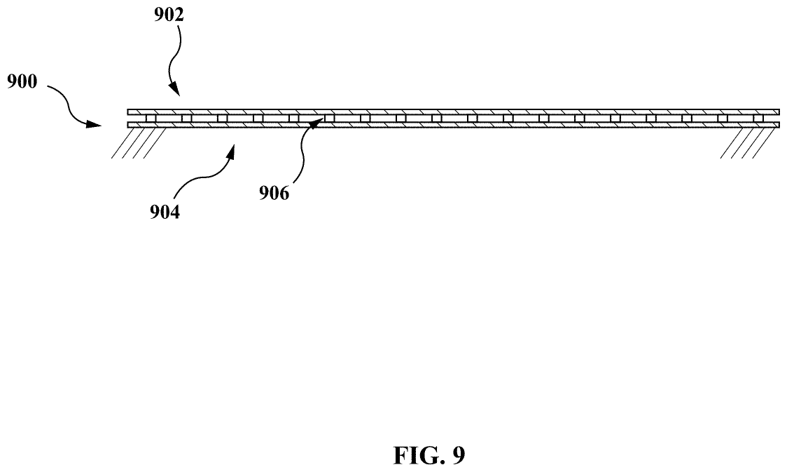

FIG. 9 illustrates a side view of the interactive layer 102 that includes electrostatic plate actuators 900. As disclosed herein, the electrostatic plate actuators 900 can include parallel plates with translucid/transparent spacers in between. The plates can operate as electrodes that create electrostatic forces. When the electrostatic force is activated with AC voltage, the electrostatic plate actuators 900 can produce a vibration like effect.

For example, as illustrated in FIG. 9, the electrostatic plate actuators 900 can include a first electrode 902 and a second electrode 904 spaced from the first electrode 902 to form a gap (e.g., an air gap) there-between. The electrodes 902 and 904 can be in the form of metal plates. Additional electrodes/plates may be used in embodiments. For example, an embodiment can include additional electrodes spaced from the first electrode 902 or the second electrode 904 to form a gap there-between. The illustrated embodiment is not intended to be limiting in any way.

In embodiments, spacers 906 can be positioned in the gap in between the first electrode 902 and the second electrode 904. In an embodiment, the spacers 906 can partially or completely fill the gap between the first electrode 902 and the second electrode 904. The configuration of the spacers 906 shown in FIG. 9 is not intended to be limiting in any way. A dielectric/insulator layer can also be positioned in between the first electrode 902 and the second electrode 904.

The spacers 906 can be any type of structure that is deformable when subjected to a force, and returned to its initial shape after the removal of the force. For example, in an embodiment, the spacers 906 can include one or more coil springs. In an embodiment, the spacers 906 can include woven cloths that extend through at least a portion of the gaps and may be compressed when subjected to a force and expands to its original shape after the removal of the force. In an embodiment, the spacers 906 have the same spring constants (k). In an embodiment, the spacers 906 can have different spring constants. For example, the spacers 906 can have a first spring constant (k₁) and the spacers 906 can have a second spring constant (k₂) that is greater than or less than the first spring constant (k₁). in an embodiment, the spring constant of the spacers 906 can be selected for a specific resonant frequency In an embodiment, the spacers 906 can be translucent and/or transparent. A complete description of electrostatic plate actuators can be found, for example, in U.S. Pat. App. Pub. No. 2016/0224115 A1 assigned to IMMERSION CORP., the content of which is incorporated by reference herein.

In embodiments, the actuators 204 can include ultrasonic actuators. In embodiments, the ultrasonic actuators can be positioned under the cosmetic layer 210. The ultrasonic actuators produce haptic effects (e.g., vibrations) by emitting ultrasonic waves that cause the cosmetic layer 210 to vibrate. A complete description of ultrasonic actuators can be found, for example, in U.S. Pat. App. Pub. No. 2012/0223880 A1 assigned to IMMERSION CORP., the content of which is incorporated by reference herein.

In embodiments, the actuators 204 can include electrostatic friction (ESF) actuators. The ESF actuators can include static ESF actuators. The static ESF actuators can generate vibrations at the fingertip of a user without requiring the finger to move, for example, when the finger is close to the surface (e.g., <1 mm). The ESF actuators can generate haptic effects that change the surface texture of the interactive surface 102. A complete description of ESF actuators can be found, for example, in U.S. Pat. App. Pub. No. 2010/0231508 A1 and U.S. Pat. App. Pub. No. 2018/0181205 A1 assigned to IMMERSION CORP., the content of which are incorporated by reference herein.

In embodiments, the actuators 204 can include vacuum actuators. In embodiments, the vacuum actuators operate to suck a user input element (e.g., finger, hand, stylus, etc.) as a form of haptic feedback. A complete description of vacuum actuators can be found, for example, in U.S. Pat. App. Pub. No. 2005/0209741 A1 assigned to IMMERSION CORP., the content of which is incorporated by reference herein.

In embodiments, the actuators 204 can include micro-fluid actuators. In embodiments, the micro-fluid actuators include a bladder and is configured to convert stretching of the bladder into a bending deformation or other form of deformation, which may be used to generate a kinesthetic haptic effect. A complete description of micro-fluid actuators can be found, for example, in U.S. patent application Ser. No. 16/145959 assigned to IMMERSION CORP., the content of which is incorporated by reference herein.

In embodiments, the actuators 204 can include gels-shaking pouches to amplify the haptic effects. The gels-shaking pouches can be positioned at any location within the interactive surface 102, for example, the interactive layer 200, the actuators 204, and/or the cosmetic layer 210. A complete description of gels-shaking pouches can be found, for example, in Coe, Patrick & Evreinov, Grigori & Raisamo, Roope, (2019), Gel-based Haptic Mediator for High-Definition Tactile Communication, 7-9, 10.1145/3332167.3357097, the content of which is incorporated by reference herein.

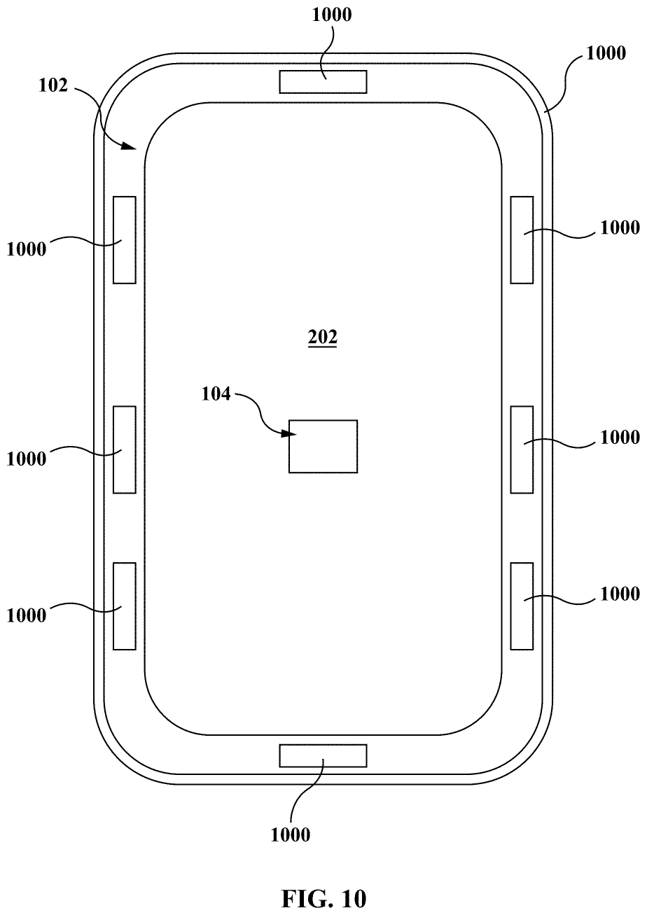

In embodiments, the actuator 204 can include multiple actuators to generate haptic effects using modal superimposition. FIG. 10 illustrates a side view of the interactive surface 102 that includes a series of actuators 1000. As illustrated, the actuators 1000 can be positioned around the interactive surface 102 and can be located at any location relative to the interactive layer 200, as discussed above. The interactive surface 102, like all structures, has multiple vibrational modes that depend on the characteristics of the surface (e.g., size, thickness, stiffness, etc.) and its mounting. A vibrational, or normal, mode of a system describes an oscillating or vibrating pattern of movement in which the parts of the system oscillate sinusoidally at the same frequency and in phase with one another. Each vibrational mode of a system corresponds to a specific fixed frequency, i.e., a natural or resonant frequency. A system has multiple vibrational modes at different frequencies, and may oscillate according to the superposition of two or more of the multiple vibrational modes. The vibrational modes of the interactive surface 102 depend on the material, size, shape, thickness, mounting structure, and other aspects of its construction. When the interactive surface 102 is subject to vibrations at the specific frequencies equal to the natural frequencies of the vibrational modes, e.g., through activation of the actuators 1000, the frequency response of the interactive surface 102 includes standing waves that establish a standing wave pattern according to the corresponding vibrational mode.

In embodiments, the actuators can establish standing waves in order to generate a haptic effect at the UI region 104. In particular, activating one of the haptic actuators 1000 at a frequency corresponding to a vibrational mode of the interactive surface 102 sets up a two-dimensional standing wave pattern in the interactive surface 102 having amplitude maximum locations and amplitude minimum locations, as discussed above in the one-dimensional case. The standing wave pattern induced by one of the haptic actuators 1000 depends on the location of the haptic actuator, the vibrational modes of the interactive surface 102 and the frequency of activation. Different activation frequencies induce different standing wave patterns. Altering the amplitude of activation of the haptic actuators 1000 alters the amplitude of the standing wave patterns. When superposed, the multiple standing wave patterns form a standing wave interference pattern that results in the localized haptic effects at the UI region 104. The multiple standing wave patterns may be caused by the activation of multiple haptic actuators 1000 at one or more frequencies, by the activation of a single haptic actuator 1000 at multiple frequencies, or by a combination of multiple haptic actuators 1000, each being activated at multiple frequencies.

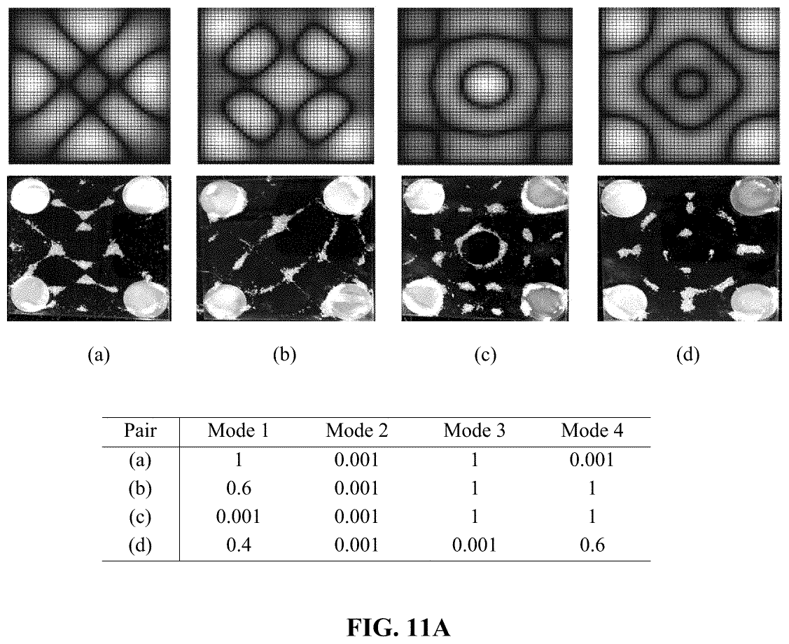

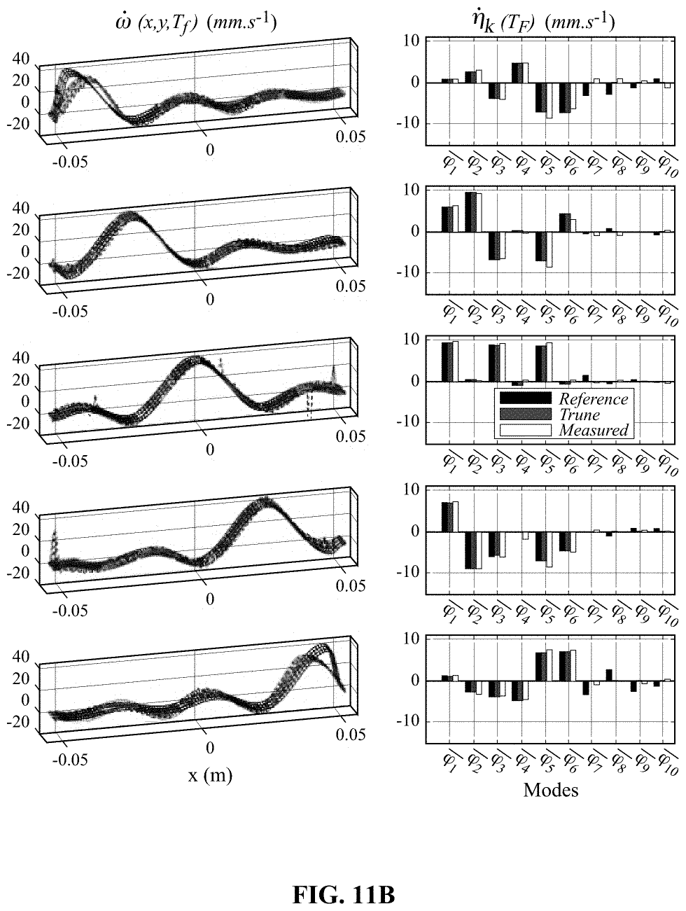

FIG. 11A illustrates examples of standing wave interference patterns that can be generated in the interactive surface 102. FIG. 11B illustrates synthesizing and approximating velocity field in order to realize a specific velocity field at the given time. See Enferad, Ehsan & Giraud-Audine, Christophe & Frédéric, Giraud & Amberg, Michel & Semail, Betty. (2019). A complete description of modal superimposition can be found, for example, in U.S. patent application Ser. No. 16/006,372 (U.S. Pat. No. 10,504,342) assigned to IMMERSION CORP., the content of which is incorporated by reference herein.

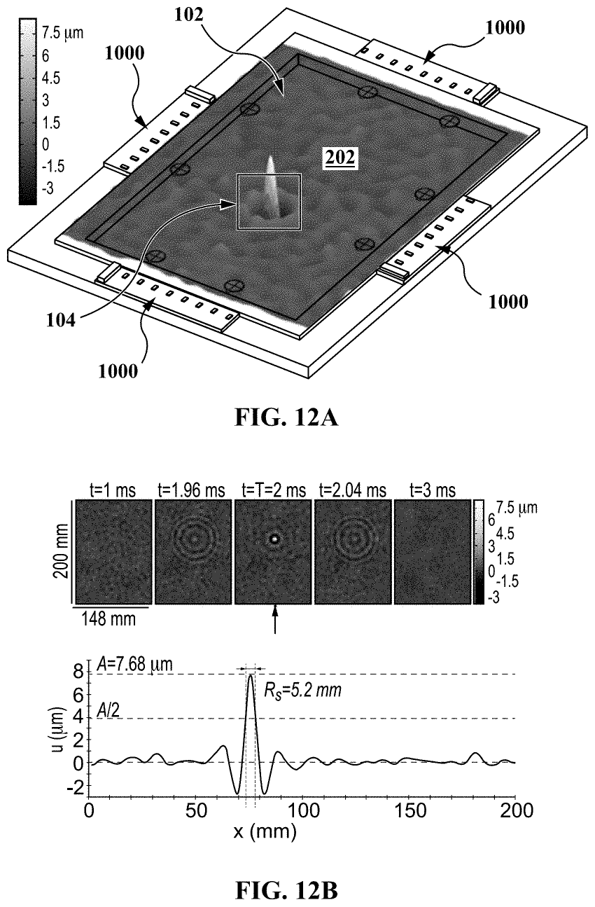

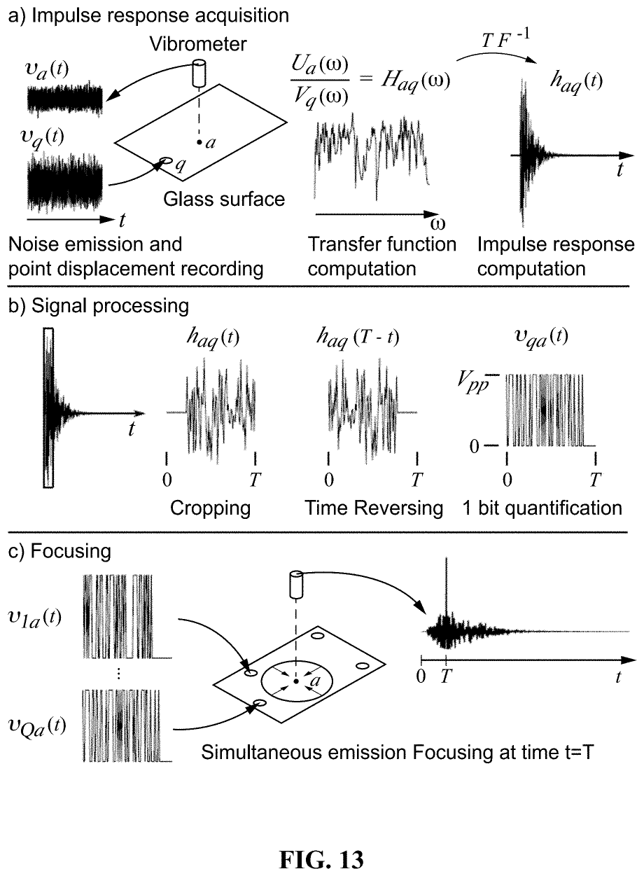

In order to determine the parameters of the standing waves, the actuators 204, e.g., actuators 1000, can utilize time reversal techniques. In time reversal techniques, the interactive surface 102 can be struck, at the UI region 104, repeatedly with a magnitude and frequency corresponding to a desired haptic effect. The actuators 1000 (or sensors positioned at the actuators 1000) can measure parameters waves received at the actuators 1000. FIGS. 12A and 12B illustrate an example of striking the interactive surface 102 and measuring the resulting waves. Based on the measured waves, parameters for generating standing waves to reproduce the haptic effect can be determine using time reversal techniques. FIG. 13 illustrates one example of an algorithm for using time reversal techniques. See Hudin et al., Modal Superposition Generating Controlled Localized Stimulations on Haptic Displays by Modal Superimposition, Journal of Sound and Vibration, 449, 10.1016/j.jsv.2019.02.039, (2015).

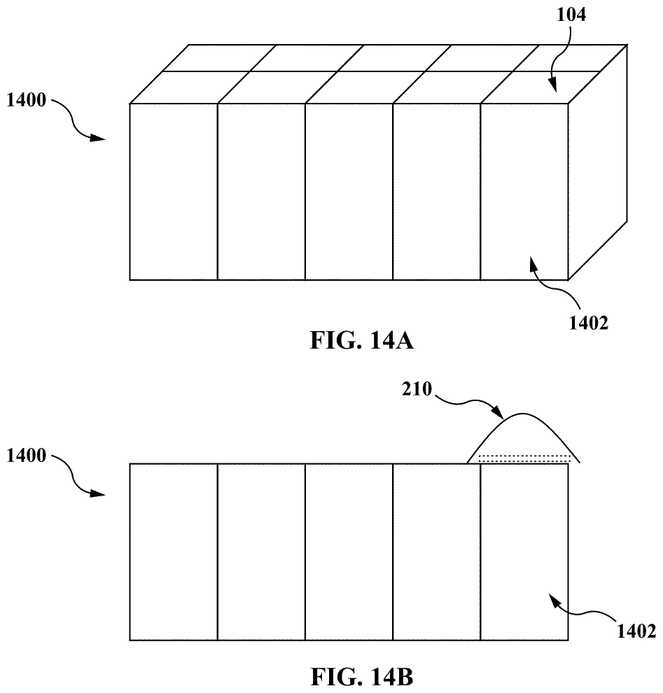

In embodiments, the interactive surface 102 can be composed of an array of cells where each cell can move a portion of the interactive surface 102 in the y-direction (e.g., up-and-down motion) associated with a UI region 10 to generate haptic effects. FIGS. 14A and 14B illustrate an example of an interactive surface 1400 that includes an array of individual cells 1402, which can generate haptic effects in a UI region 104. For example, as illustrated in FIG. 14A, the interactive surface 1402 can be composed of the individual cells 1402. The individual cells 1402 can be configured to displace and move the cosmetic layer 210 to generate a haptic effect. In embodiments, for example, an individual cell 1402 can displace the cosmetic layer 210 approximately 0.1 mm to produce accelerations of 5-10Gpp. In embodiments, the displacement can be an impulse of vibration at a specific frequency.

In embodiments, the individual cells 1402 can include components to display information associated with the UI regions 104 and receive the input from the user. In embodiments, the individual cells 1402 can include components to produce visual feedback (e.g., LEDs) and sensor components (e.g., touch sensors, capacitive sensors, proximity sensors, pressure sensors, etc.) to detect input. A complete description of individual cells to create haptic effects can be found, for example, in U.S. Pat. App. No. 2018/0130320 A1 assigned to IMMERSION CORP., the content of which is incorporated by reference herein.

In embodiments, the individual cells can include one or more actuators. In some embodiments, the actuators can be configured to output a haptic effect comprising a vibration. The actuators can comprise, for example, one or more of a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA).

In some embodiments, the actuators can be configured to output a haptic effect modulating the perceived coefficient of friction of a surface associated with the actuators. In one embodiment, the actuators can comprise an ultrasonic actuator. An ultrasonic actuator may vibrate at an ultrasonic frequency, for example 20 kHz, increasing or reducing the perceived coefficient of an associated surface. In some embodiments, the ultrasonic actuator may comprise a piezo-electric material.

In some embodiments, the actuators can use electrostatic attraction, for example by use of an electrostatic actuator, to output a haptic effect. The haptic effect may comprise a simulated texture, a simulated vibration, a stroking sensation, or a perceived change in a coefficient of friction on a surface associated with the cells 1402 of the interactive surface 1400. In some embodiments, the electrostatic actuator may comprise a conducting layer and an insulating layer. The conducting layer may be any semiconductor or other conductive material, such as copper, aluminum, gold, or silver. The insulating layer may be glass, plastic, polymer, or any other insulating material. Furthermore, the electronic device may operate the electrostatic actuator by applying an electric signal, for example an AC signal, to the conducting layer. In some embodiments, a high-voltage amplifier may generate the AC signal. The electric signal may generate a capacitive coupling between the conducting layer and an object (e.g., a user's finger or other body part, or a stylus) near or touching the actuators. Varying the levels of attraction between the object and the conducting layer can vary the haptic effect perceived by a user.

In some embodiments, the actuators can comprise a deformation device configured to output a deformation haptic effect. The deformation haptic effect may comprise bending, folding, rolling, twisting, squeezing, flexing, changing the shape of, or otherwise deforming a surface associated with the cells 1402 of the interactive surface 1400. For example, the deformation haptic effect may apply a force on the cells 1402 of the interactive surface 1400 or a surface associated with the cells 1402 of interactive surface 1400, causing it to bend, fold, roll, twist, squeeze, flex, change shape, and/or otherwise deform.

In some embodiments, the actuators can comprise gel configured for outputting a deformation haptic effect (e.g., for bending or deforming a surface associated with the interactive surface 102). For example, the actuators can comprise a smart gel. A smart gel may comprise a fluid in a polymer matrix with mechanical or structural properties that change in response to a stimulus or stimuli (e.g., an electric field, a magnetic field, temperature, ultraviolet light, shaking, or a pH variation). For instance, in response to a stimulus, a smart gel may change in stiffness, volume, transparency, and/or color. Stiffness may comprise the resistance of a surface associated with the cells 1402 of the interactive surface 1400 against deformation. In some embodiments, one or more wires may be embedded in or coupled to the smart gel. As current runs through the wires, heat is emitted, causing the smart gel to expand, contract, or otherwise change shape. This may cause the interactive surface 1400 or a surface associated with the actuators to deform. In some embodiments, a device (e.g., an electromagnet) may be positioned near the smart gel for applying a magnetic and/or an electric field to the smart gel. The smart gel may expand, contract, or otherwise change shape in response to the magnetic and/or electric field. This may cause the interactive surface 1400 or a surface associated with the actuators to deform.

As another example, the actuators can comprise a rheological (e.g., a magneto-rheological or electro-rheological) fluid. A rheological fluid comprises metal particles (e.g., iron particles) suspended in a fluid (e.g., oil or water). In response to an electric or magnetic field, the order of the molecules in the fluid may realign, changing the overall damping and/or viscosity of the fluid. This may cause the cells of the interactive surface 1400 or a surface associated with the actuators to deform.

In some embodiments, the actuators can comprise a mechanical deformation device. For example, in some embodiments, the actuators can comprise an actuator coupled to an arm that rotates a deformation component. The deformation component may comprise, for example, an oval, starburst, or corrugated shape. The deformation component may be configured to move a surface associated with the actuators at some rotation angles but not others. The actuator may comprise a piezo-electric actuator, rotating/linear actuator, solenoid, an electroactive polymer actuator, macro fiber composite (MFC) actuator, shape memory alloy (SMA) actuator, and/or other actuator. As the actuator rotates the deformation component, the deformation component may move the surface, causing it to deform. In such an embodiment, the deformation component may begin in a position in which the surface is flat. The actuator may rotate the deformation component. Rotating the deformation component may cause one or more portions of the surface to raise or lower. The deformation component may, in some embodiments, remain in this rotated state the actuator rotates the deformation component back to its original position.

Further, other techniques or methods can be used to deform or cause movement in the cells 1402 of the interactive surface 1400. For example, the actuators can comprise a flexible surface layer configured to deform its surface or vary its texture based upon contact from a surface reconfigurable haptic substrate (including, but not limited to, e.g., fibers, nanotubes, electroactive polymers, piezoelectric elements, or shape memory alloys). In some embodiments, the actuators can be deformed, for example, with a deforming mechanism (e.g., a motor coupled to wires), local deformation of materials, resonant mechanical elements, piezoelectric materials, micro-electromechanical systems (“MEMS”) elements, variable porosity membranes, or laminar flow modulation. Other types of actuators can be utilized herein such as hair or fiber vibration. See http://tangible.media.mit.edu/project/cilllia/. Additional descriptions of actuators, such as electrostimulation dots, SMAs, and other actuators, can be found, for example, in U.S. Pat. App. Pub. No. 2018/0329493 A1 and 2018/0275810 A1 and U.S. Pat. Nos. 10,331,216 B1, 10,409,376 B2, and 10,445,996 B2 assigned to IMMERSION CORP., the content of which are incorporated by reference herein.

While the above describes various actuators that may be used with the interactive surface 1400, one skilled in the art will realize that any of the above described actuators may be used with any embodiment or example described herein.

In embodiments, the isolation elements 206 can include materials and/or components that dampen or suppress haptic effects dynamically. From an examination of the equations of motions, in order to minimize vibrations around the UI region 104 to which a haptic effect is being provided, the isolation elements 206 can include components and/or materials that allow the mass of the isolation elements 206 to be increased. In embodiment, to achieve this, the isolation elements 206 can include one or more additional actuation system to move mass around to specific areas, and/or to add mass to UI regions 104 not used while the active UI regions 104 are left alone to vibrate. In some embodiments, an actuation system may use a magnet or magnetic coil that attracts metal to add mass to a specific area not in use, and when the specific area is in use, the metal-mass may be released by disengaging or de-energizing the magnet or magnetic coil, and thereafter the magnet or magnetic coil may be actuated to provide a haptic effect at the specific area.

In embodiments, the isolation elements 206 can operate by changing the dynamic properties of the isolation elements 206. In some embodiment, the isolation elements 206 can be configured as I-beam design that can change size to create variable stiffness. In some embodiments, the isolation elements 206 can utilize air jamming or particle jamming to change the dynamic properties of the isolation elements 206 to make it heavier or stiffer. A complete description of air jamming or particle jamming can be found, for example, in U.S. Pat. App. No. 2019/0384394 A1 assigned to IMMERSION CORP., the content of which are incorporated by reference herein. A complete description of materials that change stiffness can be found, for example, in U.S. Pat. App. No. 2018/0224941 A1 assigned to IMMERSION CORP., the content of which are incorporated by reference herein. In some embodiments, the isolation elements 206 can utilize MFC actuators to move mass around the isolation elements 206.

In some embodiments, the isolation elements 206 can utilize fluids, such as, Magneto-Rheological Fluids (MRF), as discussed above, to increase the mass of the isolation elements 206. In some embodiments, the isolation elements 206 can include elastomer cells or elastomer materials that change properties with temperature changes. In some embodiments, the isolation elements 206 can utilize bi-stable materials to dynamically change the properties of the isolation elements 206. A complete description of bi-stable materials can be found, for example, in U.S. Pat. App. No. 2017/0061753 A1 assigned to IMMERSION CORP., the content of which are incorporated by reference herein.

In any of the above described embodiments, the isolation elements 206 with dynamic properties can be positioned and located according to any other embodiment described herein. Any of the above described actuators associated with the isolation elements 206 can also be utilized as the actuators 204.

In any embodiments described above, to generate a haptic effect, haptic data or a haptic signal can be provided to the actuators 204. As described herein, haptic data or haptic signals include data that instructs or causes the actuators 204 to apply a force and/or forces in a predetermined pattern or sequence. For example, the haptic data or haptic signal can include values for physical parameters such as voltage values, frequency values, current values, and the like. Likewise, the haptic data or haptic signal can include relative values that define a magnitude of the haptic effect. In embodiments, the haptic data or haptic signal can be generated and/or supplied by computer system(s), processor(s), driver(s), etc. that are configured to control the operation of the actuators 204. For example, computer system(s), processor(s), driver(s), etc. can store data that relates to various user interactions with an interactive device coupled to interactive devices 100 to various haptic effects. When a user interacts, e.g., touches, the interactive device in a particular manner, the computer system(s), processor(s), driver(s), etc. can be configured generate and/or supply the haptic data or haptic signal to the actuators 204 that correspond to the user's interaction based on the stored relationships. In some embodiments, the interactive devices 100 can control the operation of the actuators 204.

Additional discussion of various embodiments is presented below.

Embodiment one is a system for delivering localized haptics. The system includes at least one actuator positioned within proximity of a user interface (UI) region of an interactive surface, wherein the UI region outputs information to a user and receives input from the user, and wherein the at least one actuator provides a haptic effect to the user when interacting with the UI region. The system also includes at least one isolation element positioned adjacent to the at least one actuator, wherein the at least one isolation element suppresses transmission of the haptic effect to an additional UI region of the interactive surface.

Embodiment two includes the system of embodiment one, wherein the at least one isolation element comprises a material that has a stiffness that is lower than a stiffness of other material of the interactive surface.

Embodiment three includes the system of embodiment one, wherein the at least one isolation element comprises a material that suppresses the transmission of the haptic effect to the additional UI region of the interactive surface.

Embodiment four includes the system of embodiment one, wherein the at least one isolation element dynamically changes at least one property to suppress the transmission of the haptic effect to the additional UI region of the interactive surface.

Embodiment five includes the system of embodiment four, wherein the at least one property includes mass, elasticity, and stiffness.

Embodiment six includes the system of embodiment four, wherein the at least one isolation element comprises at least one material that dynamically changes the at least one property.

Embodiment seven includes the system of embodiment four, wherein the at least one isolation element comprises at least one component that alters the mass of the at least one isolation element.

Embodiment eight includes the system of embodiment one, wherein the at least one isolation element is a haptic actuator associated with the additional UI region of the interactive surface.

Embodiment nine includes the system of embodiment one, wherein at least one actuator is positioned on a touch surface of the interactive surface.

Embodiment ten includes the system of embodiment one, wherein the at least one actuator is positioned with a touch surface of the interactive surface.

Embodiment eleven includes the system of embodiment one, wherein the at least one actuator is positioned on a surface opposite a touch surface of the interactive surface.

Embodiment twelve includes the system of embodiment one, wherein the at least one actuator comprises one or more of an electrostatic plate actuator, an electrostatic effect actuator, a vacuum actuator, a micro-fluid actuator, a pin actuator, a magnetic actuator, a electrode patch actuator, and a smart material actuator.

Embodiment thirteen includes the system of embodiment one, and further includes a cosmetic layer formed on a touch surface of the interactive surface, wherein the cosmetic layer reduces discontinuities due to positioning of the at least one actuator or the at least one isolation element.

Embodiment fourteen includes the system of embodiment thirteen, wherein the cosmetic layer comprises at least one sensor to detect user interaction.

Embodiment fifteen includes the system of embodiment one, wherein the at least one actuator comprises a series of actuators configured to output waves on a touch surface of the interactive surface, wherein the waves interact to produce the haptic effect.

Embodiment sixteen includes the system of embodiment fifteen, wherein a configuration of the waves is determined based on detecting input waves, wherein the input waves are generated by an input received at the UI region.

Embodiment seventeen is an interactive device including an interactive surface having a user interface (UI) region, and at least one actuator positioned within proximity of the UI region. The UI region outputs information to a user and receives input from the user, and the at least one actuator provides a haptic effect to the user when interacting with the UI region. The interactive device further includes at least one isolation element positioned adjacent to the at least one actuator, wherein the at least one isolation element suppresses transmission of the haptic effect to an additional UI region of the interactive surface.

Embodiment eighteen includes the interactive device of embodiment seventeen, wherein the at least one isolation element comprises a material that has a stiffness that is lower than a stiffness of other material of the interactive surface.

Embodiment nineteen includes the interactive device of embodiment seventeen, wherein the at least one isolation element comprises a material that suppresses the transmission of the haptic effect to the additional UI region of the interactive surface.

Embodiment twenty includes the interactive device of embodiment seventeen, wherein the at least one isolation element dynamically changes at least one property to suppress the transmission of the haptic effect to the additional UI region of the interactive surface.

Embodiment twenty-one includes the interactive device of embodiment seventeen, wherein the at least one isolation element is a haptic actuator associated with the additional UI region of the interactive surface.

Embodiment twenty-two includes the interactive device of embodiment seventeen, wherein the interactive surface comprises a touch surface and wherein the at least one actuator is positioned on the touch surface of the interactive surface.

Embodiment twenty-three includes the interactive device of embodiment seventeen, wherein the interactive surface comprises a touch surface and wherein the at least one actuator is positioned within a touch surface of the interactive surface.

Embodiment twenty-four includes the interactive device of embodiment seventeen, wherein the interactive surface comprises a touch surface and wherein the at least one actuator is positioned on a surface opposite a touch surface of the interactive surface.

Embodiment twenty-five includes the interactive device of embodiment seventeen, further including a cosmetic layer formed on a touch surface of the interactive surface, wherein the cosmetic layer reduces discontinuities due to positioning of the at least one actuator or the at least one isolation element.

Embodiment twenty-six includes the interactive device of embodiment twenty-five, wherein the cosmetic layer comprises at least one sensor to detect user interaction.

Embodiment twenty-seven includes the interactive device of embodiment seventeen, wherein the at least one actuator comprises a series of actuators configured to output waves on a touch surface of the interactive surface, wherein the waves interact to produce the haptic effect.

Embodiment twenty-eight includes the interactive device of embodiment twenty-seven, wherein a configuration of the waves is determined based on detecting input waves, wherein the input waves are generated by an input received at the UI region.

Embodiment twenty-nine is a method of providing localized haptics. The method includes determining that user interaction has been initiated at a user interface (UI) region of a touch surface, and generating a least one haptic effect in proximity to the UI region, wherein transmission of the haptic effect to an additional UI region of the interactive surface is suppressed.

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). While various embodiments according to the present disclosure have been described above, it should be understood that they have been presented by way of illustration and example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment. Stated another way, aspects of the above methods of encoding haptic tracks may be used in any combination with other methods described herein or the methods can be used separately. All patents and publications discussed herein are incorporated by reference herein in their entirety.

What is claimed is:

1. A system for delivering localized haptics, the system comprising:
at least one actuator configured to be positioned within proximity of a user interface (UI) region of an interactive surface, the at least one actuator being further configured to provide a haptic effect to a user when the user interacts with the UI region; and
at least one isolation element positioned adjacent to the at least one actuator, the at least one isolation element being configured to suppresses transmission of the haptic effect to an additional UI region of the interactive surface.

2. The system of claim 1, wherein the at least one isolation element comprises a material that has a stiffness that is lower than a stiffness of other material of the interactive surface.

3. The system of claim 1, wherein the at least one isolation element comprises a material that suppresses the transmission of the haptic effect to the additional UI region of the interactive surface.

4. The system of claim 1, wherein the at least one isolation element dynamically changes at least one property to suppress the transmission of the haptic effect to the additional UI region of the interactive surface.

5. The system of claim 4, wherein the at least one isolation element comprises at least one material that dynamically changes the at least one property.

6. The system of claim 4, wherein the at least one property includes mass, elasticity, and stiffness.

7. The system of claim 6, wherein the at least one isolation element comprises at least one component that alters the mass of the at least one isolation element.

8. The system of claim 1, wherein the at least one isolation element is an actuator associated with the additional UI region of the interactive surface.

9. The system of claim 1, wherein the at least one actuator comprises one or more of an electrostatic plate actuator, an electrostatic effect actuator, a vacuum actuator, a micro-fluid actuator, a pin actuator, a magnetic actuator, a electrode patch actuator, and a smart material actuator.

10. The system of claim 9, wherein the at least one isolation element comprises one or more of an electrostatic plate actuator, an electrostatic effect actuator, a vacuum actuator, a micro-fluid actuator, a pin actuator, a magnetic actuator, a electrode patch actuator, and a smart material actuator.

11. The system of claim 1, wherein the at least one actuator comprises a series of actuators configured to output waves on a touch surface of the interactive surface, wherein the waves interact to produce the haptic effect, and wherein a configuration of the waves is determined based on detecting input waves, and the input waves are generated by an input received at the UI region.

12. An interactive device comprising:
an interactive surface having a user interface (UI) region, the UI region being configured to output information to a user and receive input from the user;
at least one actuator positioned within proximity of the UI region, the at least one actuator being configured to provide a haptic effect to the user when the user interacts with the UI region; and
at least one isolation element positioned adjacent to the at least one actuator, the at least one isolation element being configured to suppress transmission of the haptic effect to an additional UI region of the interactive surface.

13. The device of claim 12, wherein the at least one isolation element dynamically changes at least one property to suppress the transmission of the haptic effect to the additional UI region of the interactive surface.

14. The device of claim 12, wherein the at least one isolation element comprises a material that has a stiffness that is lower than a stiffness of a material of the interactive surface.

15. The device of claim 12, wherein the at least one isolation element comprises a material that suppresses the transmission of the haptic effect to the additional UI region of the interactive surface.

16. The device of claim 12, wherein the at least one isolation element is an actuator associated with the additional UI region of the interactive surface.

17. The device of claim 16, wherein the actuator associated with the additional UI region of the interactive surface is configured to provide a haptic effect to the user when the user interacts with the additional UI region.

18. The device of claim 12, wherein the at least one actuator comprises one or more of an electrostatic plate actuator, an electrostatic effect actuator, a vacuum actuator, a micro-fluid actuator, a pin actuator, a magnetic actuator, a electrode patch actuator, and a smart material actuator.

19. The device of claim 18, wherein the at least one isolation element comprises one or more of an electrostatic plate actuator, an electrostatic effect actuator, a vacuum actuator, a micro-fluid actuator, a pin actuator, a magnetic actuator, a electrode patch actuator, and a smart material actuator.

20. A method of providing localized haptics, the method comprising:
determining that user interaction has been initiated at a user interface (UI) region of a touch surface; and
generating a least one haptic effect in proximity to the UI region, wherein transmission of the haptic effect to an additional UI region of the interactive surface is suppressed.
